(19) United States
(12) Patent Application Publication
(10) Pub. No.: US 2020/0060318 A1
(43) Pub. Date: Feb. 27, 2020

(54) METHOD FOR THE CONTINUOUS COATING OF FOOD PRODUCTS, IN PARTICULAR FROZEN FOOD PRODUCTS, WITH CONTROLLED ROTOR HEATING

(71) Applicant: BONDUELLE, Renescure (FR)

(72) Inventors: Salvatore FABOZZI, Renescure (FR); Sébastien SENECHAL, Renescure (FR)

(73) Assignee: BONDUELLE, Renescure (FR)

(21) Appl. No.: 16/610,998

(22) PCT Filed: Apr. 27, 2018
(86) PCT No.: PCT/FR2018/051069

§ 371 Date: Nov. 5, 2019

(30) Foreign Application Priority Data
May 10, 2017 (FR) 17 54098

(51) Int. Cl. A23L 3/375; A23L 3/00; A23P 20/15

(52) U.S. Cl. CPC A23L 3/375; A23P 20/15; A23L 3/001

(57) ABSTRACT

A method for coating food products with a coating substance including: a step a) of supercooling the food products, by providing external frigories, to a temperature lower than the initial temperature of same, before contacting the food products with the coating substance, and subsequently, a step b) of contacting the supercooled food products obtained in step a) with the coating substance. In step b): (i) the supercooled food products are contacted with the coating substance in a treatment chamber, (ii) the food products are stirred by a motorised mechanised system, including at least one stirring member, internal to the treatment chamber, (iii) the at least one stirring member is heated, and the intensity of the heating is adjusted, without excess heating, so as to avoid the accumulation of materials on the stirring member.

The invention relates to a method for coating food products with a (liquid or paste-like) substance which comprises one or more steps of providing frigories in order to cause crusting of the coating substance around the food products.

The food products may be vegetables, legumes, meat, fish, fruit or cereals, alone or in mixture.

The invention concerns, in particular, coating methods comprising:
a step a) of supercooling the food products, by providing external frigories, to a temperature lower than the initial temperature of same, before contacting the food products with the coating substance, and subsequently
a step b) of contacting the supercooled food products obtained in step a) with the coating substance, the coating around the products being formed at this step by the freezing of said coating substance under only the action of the transfer of frigories from the food products to the coating substance, in other words without providing external frigories.

Document FR 2789270 A1 discloses such a coating method for which the steps a) and b) are carried out continuously.

Optionally, and according to the invention, the freezing of the coating substance around the food products may be only partial at the end of step b), the method being able to also comprise an additional step c) where the coated products obtained in step b) are provided with external frigories until total freezing is obtained of the coating substance.

The initial temperature of the products in step a) may correspond to a frozen state, for example the temperature being between −20° C. and −10° C.

The invention concerns coating methods for which steps a) and b) and, if necessary, step c) are preferably carried out continuously, and yet more particularly to coating methods, on the industrial scale, enabling large production capacities to be attained.

The invention concerns, more particularly, in step b) which has been implemented by the applicant in test phase in a production line having a unit for coating and contacting the coating substance, comprising a treatment chamber, and a stirring and advancing system with two contrarotating rotors, ensuring the stirring of the food products in the treatment chamber: depending on the (preferably continuous) flow rate, the coating substance is supplied into this treatment chamber in order to spray the supercooled food products, in particular at a plurality of injection points along a defined length of treatment chamber. The rest of this length of chamber is dedicated to finishing the crusting of the coated substance.

The treatment chamber is supplied, according to a determined flow rate, with supercooled products from step a), at at least one supply opening of the chamber. The two contrarotating rotors are rotated. The contrarotating rotors, rotated in this way, advance the food products according to a determined residence time in the treatment chamber: along their path, the supercooled food products are sprayed with the coating substance, and with the aim of contacting the coating substance with the food products, and the at least partial crusting of the coating substance (under the action of the transfer of frigories from the food products to the coating substance, and in accordance with step b).

The rotation of the rotors also stirs the food products. The stirring action of the rotor also ensures a relatively uninterrupted movement between the food products, and thus avoids their agglomeration under the intense cold. This stirring also distributes the coating substance injected into the treatment chamber over the entire surface of the food products, and with the aim of obtaining a uniform coating around the food products.

Such a coating method has been tested when the unit for coating and contacting the coating substance involves two contrarotating rotors, substantially juxtaposed and parallel, each formed of a substantially cylindrical shaft, and provided with an assembly of members substantially radial to the shaft, regularly distributed along the length of the shaft following a helical path.

Such a continuous coating method has proven satisfactory when the production capacities were modest, or even medium or again when the coating substance exhibits certain properties (low coating proportion, nature of the substance, dry matter content, fat and salt content).

By contrast, problems with blocking appeared when the production capacities were increased and for long line opening times, and/or when the coating substance proportion was large, typically greater than 10% by weight with respect to the food products, and/or when the nature of the coating substance lent itself to it, and/or according to its dry matter content or again according to its fat and salt content: during the implementing of such a method, a progressive accumulation of the coating substance is observed in the treatment chamber, passing through various rheological/thermodynamic states could lead to the freezing and blocking of the chamber of the unit at the end of several hours of production.

The analysis of the treatment chamber by the inventors led to the discovery that the accumulation of coating substance forms substantially on the rotors, and, in particular, the radial members of the rotor: the layer covers the peripheral surface, thickening radially, until filling the interspace between the two contrarotating rotors. In such a case, the food products can no longer correctly circulate between the rotors; the method is therefore totally blocked.

For certain coating substances, and even in the case of relatively modest production capacities, the inventors have observed inequalities in the quality of the coating around the food products, namely that the crusted coating substance was not uniformly distributed over the entire surface of the food products.

The aim of the present invention is to overcome the above-mentioned disadvantages by providing a method for coating food products which, at least according to one embodiment, remains reliable, even when the production capacities are large, whatever the opening times of the coating line and/or the proportion of coating substance, and/or its dry matter content, or again its fat and salt content.

Another aim of the present invention is to provide, at least according to one embodiment, a coating method which substantially improves the quality of the coating by enabling the coating substance to uniformly cover the entire surface of the food products.

Other aims and advantages of the present invention will become apparent from the following description, which is given by way of indication only and which is not intended to be limiting.

### SUMMARY OF THE INVENTION

The applicant has succeeded in preventing the phenomenon of accumulation of coating substances on motorised stirring members (i.e. the two contrarotating rotors) by implementing a controlled heating during the implementation of the step b), with a conductive transfer of heat, in particular to the radial members of the rotors.

It is understood that the implementation of such a heating is delicate and atypical and that it is necessary to supply to the stirring member (i.e. the rotors) the quantity of heat sufficient to prevent this accumulation on the member, but without excessive heating under penalty of no longer obtaining the freezing (at least partial) of the coating substance which must result from step b) by transfer of frigories from the supercooled food products to the coating substance.

Particular attention is therefore paid to controlling the intensity of heating sufficiently finely to achieve this objective; in the case of electrical (resistive) heating it has been possible to finely control the intensity of heating using a power control by “PWM” (Pulse Width Modulation). By reducing the duty cycle of the PWM control, the heating intensity is reduced. By contrast, by increasing the duty cycle of the PWM control, the heating intensity is increased.

Such controlled heating during the implementation of step b) made it possible to avoid problems of blocking of the line when production capacities are large, typically on the order of one tonne/hour (or greater) of coated food products.

In an unexpected manner, and even for more modest production capacities (less than 1 tonne/hour of coated products) for which the problems of accumulation are not significant, the inventors have observed a substantial improvement in the quality of the coating, namely a better distribution of the coating substance around the food products and a substantial reduction of fines, in comparison to the implementation of step b), without heating.

According to the current understanding of the inventors, the implementation of the controlled heating advantageously slows the time required for the coating substance to solidify and freeze. Without heating and transfer of heat to the coating substance, the freezing is often too abrupt to provide the coating substance with the necessary time to uniformly cover the entire surface of the food products.

### DISCLOSURE OF THE INVENTION

The invention also relates to a method for coating food products with a coating substance comprising:
a step a) of supercooling the food products, by providing external frigories, to a temperature lower than the initial temperature of same, before contacting the food products with the coating substance, and subsequently
a step b) of contacting the supercooled food products obtained in step a) with the coating substance, the coating around the products being formed at this step by the freezing of said coating substance under only the action of the transfer of frigories from the food products to the coating substance, in other words without providing external frigories and in which steps a) and b) are preferably carried out continuously.

According to the invention, and in step b):
the supercooled food products are contacted with the coating substance in a treatment chamber,
the food products are stirred by means of a motorised mechanised system, comprising at least one stirring member, internal to said treatment chamber, movable with respect to said treatment chamber,
said at least one stirring member is heated, and the intensity of the heating is adjusted without excess heating, so that the distribution of the coating substance around the food products is uniform and/or to avoid the accumulation of material on said stirring member, while ensuring the coating around the food products by freezing of the coating substance under the action of the transfer of frigories from the food products to the coating substance.

According to optional features of the invention, taken alone or in combination:
said at least one stirring member is a rotor; in particular, said motorised mechanised system comprises two stirring members respectively formed by two contrarotating rotors, which are juxtaposed and substantially parallel;
said at least one rotor, where necessary each of the two contrarotating rotors, comprises radial members distributed along the rotor and configured so as to ensure the advance of the material along said treatment chamber during rotating of the rotor or, if necessary, during rotating of the contrarotating rotors;
the heating of the stirring member is an electrical induction heating or resistive heating;
the heating of the stirring member is an electrical heating and wherein the power is controlled by pulse-width modulation, and the step of adjusting the intensity of heating is carried out by modifying the duty cycle of the pulse-width modulation power control;
the electrical circuit for implementing the electrical heating comprises at least one portion embarked on the rotor, the embarked portion having, in particular, one or more electrical resistances, and a portion rigidly attached to the frame of the treatment chamber, connected to the electrical power source, sliding electrical contacts ensuring the electrical connection between the two portions of the electrical circuit, which can move with respect to one another;
the freezing of the coating substance around the food products is partial at the end of step b), the method comprising a step c) where the products coated in step b) are provided with external frigories until total freezing is obtained of the coating substance forming the coating around the food products (without injection of coatings substance).

According to another embodiment, the heating of the stirring member is obtained by heat exchange between a heat transfer fluid and said stirring member. In such a case, the stirring member, in particular the rotor or rotors are provided with internal channels for circulation of the heat transfer fluid. In such a heating method, a step of adjusting the intensity of heating can be carried out by increasing or reducing the temperature of the heat transfer fluid before it exchanges heat with said stirring member, and/or increasing or reducing the flow rate of heat transfer fluid arriving at said at least one stirring member.

In general, the initial temperature of the products corresponds to a frozen state, for example with the temperature being between −20° C. and −10° C.

According to an embodiment, the temperature of the supercooled food products at the end of step b) is between −65° C. and −25° C. and/or the temperature of the coating substance before being contacted with the supercooled products is greater than 0° C., such as for example at ambient temperature.

In general, the provision of external frigories according to step a) and/or according to step c) can be obtained by injection of a cryogenic fluid and the cryogenic fluid is directly contacted with the food products of step a), and/or with the coated food products of step c).

The method according to the invention has a particular application on a production line for production capacities greater than 1 tonne/hour, and preferably greater than 2 tonnes/hour, of coated food products and in order to avoid the accumulation of material on said stirring member, or even additionally significantly improving the distribution of the coating substance around the food products.

The method according to the invention also has a particular application, even on production lines with more modest capacities, less than 1 tonne/hour, for example less than 500 kg/hour, of coated food products in order to improve the quality of the coating, namely to obtain a better distribution of the coating substance.

### DESCRIPTION OF THE FIGURES

The invention will be better understood on reading the accompanying description of the attached drawings, of which:

FIG. 1 is a view of a facility suitable for implementing the coating method according to the invention,

FIG. 2 is a view from above of the unit for coating and contacting the coating substance, of the facility of FIG. 1, which comprises an advancing and stirring system with two contrarotating rotors,

FIG. 3 is a schematic view of the shaft of a rotor of the advancing system of FIG. 2, which comprises in turn an electrical heating circuit with an assembly of electrical resistances, and

FIG. 4 is a graph of the electrical voltage as a function of time, illustrating the power control of the electrical circuit by pulse-width modulation.

### DETAILED DESCRIPTION

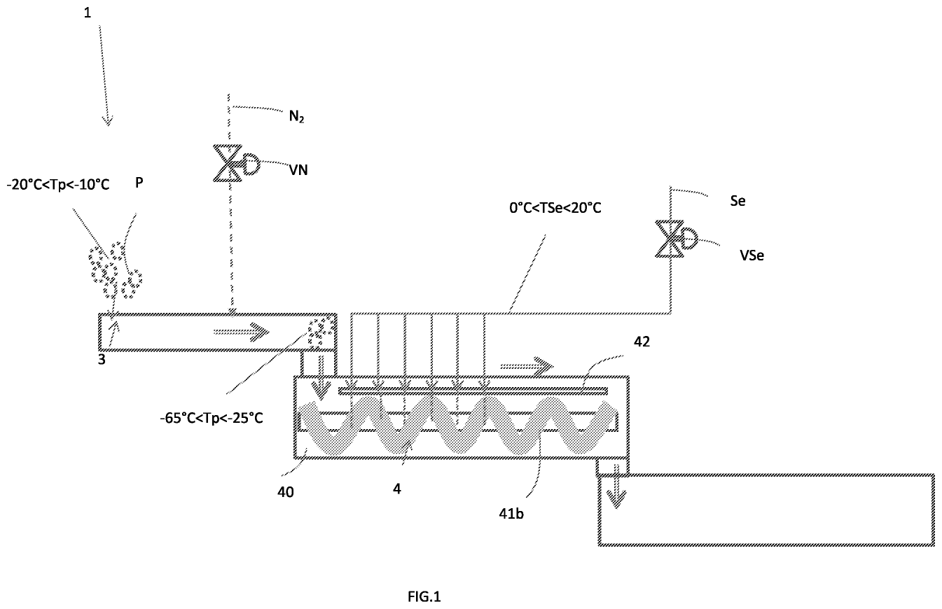

FIG. 1 also illustrates (by way of non-limiting example) a coating facility 1 suitable for implementing the method for coating food products P with a coating substance Se, according to the invention by implementing steps a) and b) as described above. This facility 1 comprises, successively, in the direction of treatment of products, a supercooling unit 3 and a unit 4 for coating and contacting the coating substance.

The food products P are supplied continuously (or discontinuously) into the supercooling unit 3.

The supercooling of step a) obtained by providing external frigories on the food products P, with the injection of cryogenic fluid (for example liquid nitrogen or CO₂) in the super cooling unit 3 at one or more injection points.

The flow of the cryogenic fluid is controlled in order to obtain the determined temperature (for example −35° C.) of the supercooled products at the end of step a) which is higher than −65° C. and lower than −25° C., at the outlet of the supercooling unit 3. This control can be implemented by means of a “proportional” valve V_{N}.

The supercooled products, coming from step a) continuously (or discontinuously) supplying the input of the unit 4 for coating and contacting the coating substance, in particular by gravity.

This coating unit 4 enables the implementation of step b) of the coating method, and comprises, for this purpose:
a treatment chamber 40, forming a cradle for an advancing and stirring system,
the advancing and stirring system which comprises two contrarotating rotors 41a, 41b,
an injection system 42 for injecting the coating substance Se into the treatment chamber 40 of defined length,
a length of the chamber (after the injection system 42) in order to allow the crusting of the coating substance Se, in other words without coating substance injection.

Each of the rotors comprises a shaft 43, in particular substantially cylindrical, along which members 44 are distributed, substantially radially. These members 44 are distributed along the length of the shaft following a helical path, and close to one another. During rotation of the rotor 41a or 41b, the members 44 enable stirring of the food products P. Their arrangement also allows the products to be pushed in a manner similar to an Archimedes' screw.

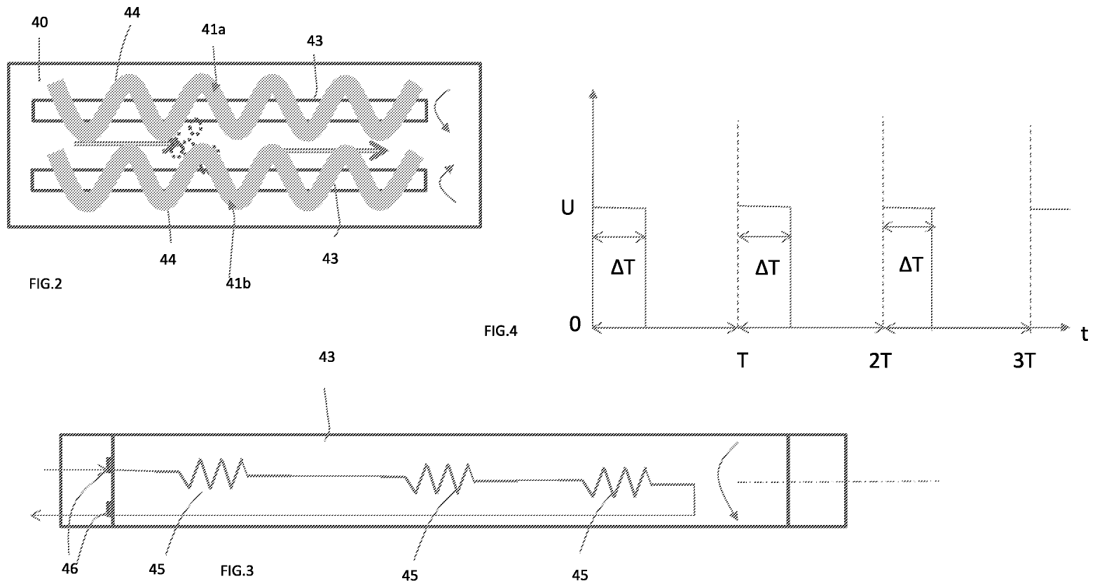

By rotating the rotors 41a and 41b in opposite directions, it is possible to cause the advance of the food products P along the treatment chamber 40, from the inlet to an outlet, and as illustrated by the double arrow of FIG. 2.

Over the first portion of the path, the coating substance Se is continuously injected at a plurality of injection points along the treatment chamber 40 by means of the system 42. The coating substance may be at ambient temperature, but in all cases higher than 0° C. The flow rate of the coating substance Se can be controlled by a proportional control valve V_{Se}, as a function of the desired proportion of coating substance Se and of the flow rate of the food products P. The coating substance Se comes into contact with the supercooled food products in the enclosure 40: the coating is then at least partially crusted by transfer of frigories from the food products to the coating substance, in other words without supplying external frigories (i.e. without injecting cryogenic fluid into the chamber 40) and this over the length of the chamber 40 left free of the system 42.

Heating the Rotors

Notably, and according to the invention, and during the implementation of step b), the rotors 41a and 41b are positively heated in order to limit the transfer of frigories onto the shaft 43 and the members 44 of rotors 41a and 41b. The sufficient quantity of energy necessary for stopping the accumulation of the coating substance Se on the rotors 41a and 41b and their radial members 44 is thus provided, and/or again for slowing the freezing of the coating substance, but without excess heating under penalty of no longer obtaining the (at least partial) freezing of the coating substance which must result from step b).

Particular attention is therefore paid to controlling the intensity of heating sufficiently finely to achieve this objective; in the case of electrical (resistive) heating it has been possible to finely control the intensity of heating using power control by “PWM” (Pulse Width Modulation).

Such a control is illustrated by the graph of FIG. 4 which illustrates this power control, and more particularly the voltage U, as a function of time. The heating is controlled by a voltage pulse of width ΔT, at each time period T. The duty cycle α (in percent) is

$$α = \frac{100 \times Δ T}{T} .$$

By reducing the duty cycle α of the PWM control, the heating intensity is reduced. By increasing the duty cycle α of the PWM control, the heating intensity is increased. This duty cycle is adjusted to each production campaign in order to prevent the accumulation of the coating substance Se, and without excess heating as explained above. FIG. 4 illustrates the internal electrical heating circuit of the shaft 43 of each rotor 41a or 41 b which comprises an assembly of electrical resistances 45, mounted to rotate with the shaft 43 of the rotor. The electrical circuit comprises sliding electrical contacts 46, between the rotating part of the circuit embarked on the shaft 43 and the stationary part of the circuit connected to the electrical power source.

### REFERENCE SIGNS

1. Coating facility
3. Supercooling unit,
4. Unit for coating and contacting the coating substance,
40. Treatment chamber,
41a, 41b. Contrarotating rotors,
42. System for injecting the coating substance,
43. Shafts (rotors),
44. Radial members (rotors),
45. Electrical resistances (rotor heating),
46. Sliding electrical contacts.
N₂. Cryogenic liquid,
Se. Coating substance,
P. Food products,
Tp. Temperature of the food products,
V_{N}. Valve for controlling flow of the cryogenic fluid,
V Valve for controlling flow of the coating substance,
U. Supply voltage of the electrical heating circuits inside the rotors.

1-17. (canceled)

18. A method for coating food products with a coating substance, comprising:
a step a) of supercooling the food products, by providing external frigories, to a temperature lower than the initial temperature of same, before contacting the food products with the coating substance, and subsequently
a step b) of contacting the supercooled food products obtained in step a) with the coating substance, the coating around the products being formed at this step by the freezing of said coating substance under only the action of the transfer of frigories from the food products to the coating substance, in other words without providing external frigories, characterised in that in step b):
the supercooled food products are contacted with the coating substance in a treatment chamber,
the food products are stirred by means of a motorised mechanised system, comprising at least one stirring member, internal to said treatment chamber, movable with respect to said treatment chamber,
said at least one stirring member is heated, and the intensity of the heating is adjusted without excess heating, so that the distribution of the coating substance around the food products is made uniform and/or to avoid the accumulation of material on said stirring member, while ensuring the coating around the food products by the freezing of the coating substance under the action of the transfer of frigories from the food products to the coating substance.

19. The method according to claim 18, wherein said at least one stirring member is a rotor.

20. The method according to claim 18, wherein said motorised mechanised system comprises two stirring members formed by two juxtaposed contrarotating rotors.

21. The method according to claim 20, wherein said at least one rotor, where necessary each of the two contrarotating rotors, comprises radial members distributed along the rotor and configured so as to ensure the advance of the material along said treatment chamber during rotating of the rotor or, if necessary, during rotating of the contrarotating rotors.

22. The method according to claim 18, wherein the heating of the stirring member is electrical induction heating or resistive heating.

23. The method according to claim 22, wherein the heating of the stirring member is an electrical heating and wherein the power is controlled by pulse-width modulation, and the step of adjusting the intensity of heating is carried out by modifying the duty cycle of the pulse-width modulation power control.

24. The method according to claim 22, wherein the stirring member is a rotor, and wherein the electrical circuit for implementing the electrical heating comprises at least one portion embarked on the rotor, the embarked portion having, in particular, one or more electrical resistances, and a portion rigidly attached to the frame of the treatment chamber, connected to the electrical power source, sliding electrical contacts ensuring the electrical connection between the two portions of the electrical circuit, which can move with respect to one another.

25. The method according to claim 18, wherein the freezing of the coating substance around the food products is partial at the end of step b), the method comprising a step c) where the coated products obtained in step b) are provided with external frigories until total freezing of the coating substance is obtained forming the coating around the food products.

26. The method according to claim 18, wherein the heating of the stirring member is obtained by heat exchange between a heat transfer fluid and said stirring member.

27. The method according to claim 26, wherein a step of adjusting the intensity of heating is carried out by increasing or reducing the temperature of the heat transfer fluid, before it exchanges heat with said stirring member, and/or increasing or reducing the flow rate of heat transfer fluid arriving at said at least one stirring member.

28. The method according to claim 18, wherein the initial temperature of the products corresponds to a frozen state, for example being between −20° C. and −10° C.

29. The method according to claim 18, wherein the temperature of the supercooled food products at the end of step b) is between −65° C. and −25° C. and wherein the temperature of the coating substance before being contacted with the supercooled products is greater than 0° C., such as for example at ambient temperature.

30. The method according to claim 18, wherein the provision of external frigories in step a) and/or step c) is carried out by injection of a cryogenic fluid and the cryogenic fluid is directly contacted with the food products of step a), and/or with the coated food products of step c).

31. The method according to claim 18, for production capacities greater than 1 tonne/hour of coated food products, for example greater than 2 tonnes/hour, and for which said at least one stirring member is heated, and the intensity of the heating is adjusted, without excess heating, at least so as to avoid the accumulation of material on said stirring member.

32. The method according to claim 18, for production capacities less than 1 tonne/hour of coated food products, for example less than 500 kg per hour, and for which said at least one stirring member is heated, and the intensity of the heating is adjusted, without excess heating, at least so that the distribution of the coating substance around the food products is uniform.

33. The method according to claim 18, wherein the food products are selected from the group consisting of vegetables, legumes, meat, cereals, fruits, fish and combinations thereof.

34. The method according to claim 18, wherein steps a) and b), or even if necessary, c) are carried out continuously.
